(19) United States
(12) Patent Application Publication
(10) Pub. No.: US 2010/0262576 A1
(43) Pub. Date: Oct. 14, 2010

(54) METHODS FOR DETERMINING A PATH THROUGH CONCEPT NODES

(75) Inventors: Paul Stockwell, Tamborine (AU); Andrew E. Smith, Jindalee (AU); Janet Wiles, St. Lucia (AU)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: LEXIMANCER PTY LTD., St. Lucia, QL (AU)

(21) Appl. No.: 12/808,253

(22) PCT Filed: Dec. 17, 2008
(86) PCT No.: PCT/AU08/01915

§ 371 Date: Jun. 15, 2010

(30) Foreign Application Priority Data
Dec. 17, 2007 (AU) 2007906891
Dec. 20, 2007 (AU) 2007907004

(51) Int. Cl. G06N 5/02; G06F 17/27

(52) U.S. Cl. 706/55

(57) ABSTRACT

A method for determining a path through concept nodes. The method includes calculating a spatial cost function between adjacent concept nodes in a lower dimensional layout representation of a network of concepts in a n-dimensional space and determining a path that follows a minimum spatial cost function through the concept nodes. The spatial cost function may be used to predict a next node in the path. The method may also include receiving an origin concept node or a goal concept node.

### RELATED APPLICATIONS

This is a §371 of International Application No. PCT/AU2008/001915, with an international tiling date of Dec. 17, 2008 (WO 2009/076728 A1, published Jun. 25, 2009), which is based on Australian Patent Application No. 2007906891 filed Dec. 17, 2007 and Australian Patent Application No. 2007907004 filed Dec. 20, 2007.

### TECHNICAL FIELD

This disclosure generally relates to a method for determining a path through nodes of concepts. More particularly, the disclosure relates to a method for identifying a path through concept nodes. Specifically, these nodes can correspond to concepts, entities, and categories.

### BACKGROUND

The current period of human history has been referred to as the Information Age because of the massive increase in information accessible to the average person. The majority of this available information is stored in computer systems in textual form, for example web pages. While there has been an explosion in the amount of accessible information, there has not been a corresponding improvement in the tools useful for accessing the information. One of the greatest challenges in the Information Age is to sort the quantity of accessible information to identify the quality information.

One available tool is known as ‘Leximancer®’ and is described in detail at www.leximancer.com and in a number of publications including A. E. Smith, 2003; A. E. Smith, 2000, Machine Mapping of Document Collections; and A. E. Smith, 2000, Machine Learning of Well-defined Thesaurus Concepts.

Leximancer® operates by transforming lexical co-occurrence information from natural language (contained in documents, web pages, newspaper articles, etc) into semantic patterns in an unsupervised manner. The extracted semantic patterns are displayed by means of a conceptual map that provides an overview of the concepts covered by the documents. The concept map displays five important sources of information about the analysed text:

the main concepts discussed in the document set;

the relative frequency of each concept;

how often concepts co-occur within the text;

the centrality of each concept; and

the similarity in contexts in which the concepts occur.

Leximancer® uses a number of features to assist the user to identify key aspects of the data. The brightness of a concept is related to its frequency (i.e. the brighter the concept, the more often it appears in the text); the brightness of links between concepts relate to how often the two connected concepts co-occur closely within the text; and the nearness in the map indicates that two concepts appear in similar conceptual contexts (i.e. they co-occur with similar other concepts).

A large corpus of documents will result in a very complex map with many concepts and multiple connections between concepts. The Leximancer® user interface allows the user to adjust the number of concepts displayed and to turn off the display of connections between concepts. Nonetheless, it may still be difficult to extract full value from the maps of large sets of documents.

Leximancer® is not the only tool available for extracting information from a large corpus of documents. One such other tool is described in United States patent application number 2003/0217335, assigned to Verity Inc, and uses a method of automatically discovering concepts from a corpus of documents by extracting signatures. Verity defines a signature as a noun or noun-phrase. The similarity between signatures is computed using a statistical measure and a cluster of related signatures, as determined by the statistical measure, defines a concept. The concepts are then built into a hierarchy as a means of visualising key concepts within the corpus. The hierarchical display of Verity is an improvement from the unstructured corpus but falls short of a useful visualisation tool.

Another of these other tools, described in WO2003/073331 and WO 2005/081139, which are the international publications of PCT patent applications to Attenex Corporation, uses a method of arranging concept clusters in thematic relationship in a two dimensional visual display space. According to Attenex, concepts belonging to a theme are grouped together, and then the clusters of concepts are placed in the display space according to the theme(s) to which they belong.

Yet another tool described in WO2006/113970, which is a publication of a PCT application assigned to the present applicant, describes a method of analyzing a corpus of documents using a distance metric based on connectedness of nodes, which is derived from a co-occurrence measure, to identify thematic groups of nodes.

TextPool (Albrecht-Buehler et al.) is another tool, that monitors and explores large, rapidly changing information streams and displays results as a partially connected graph using a force-directed layout method to implement temporal pooling in real-time.

A similarity measure, such as determined by the methods discussed above can be usefully in providing a graphical display of related concepts. One method is the concept map used by Leximancer® in which the statistical similarity is treated as a distance metric so that the similarity between concepts is related to the distance between concepts on the concept map. There are a number of techniques for calculating a distance metric that can be used to establish a spatial layout of nodes (whether concepts, words, nouns, noun-phrases, etc) in a network.

One such method is Multi Dimensional Scaling (MDS). MDS is a method for projecting a symmetric matrix of node proximities, which is equivalent to a graph with edges, onto a metric space. MDS attempts to faithfully scale the between-node proximities (edge weights) to metric distances between points in the lowest dimensional space possible. The metric space may need to be more than two dimensional to obtain acceptable agreement.

To be more precise, MDS is a particular group of algorithms for achieving this scaling which share certain assumptions—MDS is based around a representation function which directly scales each graph edge weight to a metric distance. The solution is usually found by first calculating the target distance between each pair of nodes using the representation function. Next, random starting locations are assigned and each node is advanced towards its target separation from each other node by fractional increments of the target separation. Often simulated annealing is required to find better solutions. There are other techniques which attempt to achieve similar results by different means. Factor Analysis and Principal Components Analysis decompose the proximity matrix into basis vectors. These being orthogonal provide a multidimensional metric space in which the nodes are located. Solutions found by these methods tend to be in higher dimensional spaces than MDS, and are consequently harder to visualise. For a discussion of these methods, see Modern multidimensional scaling: theory and applications by Ingwer Borg and Patrick Groenen (Springer, 1997).

There are other more modern variants of MDS which can be grouped under the name of Force Directed Graphing. These algorithms assign attractive and repulsive force functions of separation distance between nodes. These functions are then used to calculate the energy of a candidate layout of the network. Optimisation methods must still be designed to utilise this fitness function.

Another approach is known as Self Organising Maps (SOM). SOM takes the initial graph and edge weights as input to a competitive neural network which then performs unsupervised clustering of the nodes into a regular low-dimensional grid (normally 2-D). A reference for this method is: Self-Organizing Maps by Teuvo Kohonen, Springer Series in Information Sciences, Vol. 30, Springer, Berlin, Heidelberg, New York, 1995, 1997, 2001, 3rd edition.

In broad terms, the prior art techniques for displaying concepts extracted from a corpus of documents fall into two primary groupings, those that display a tree-like structure and those that display a node map. Of these, the map display is more useful for displaying a large number of related nodes. However, as the number of nodes increases the capacity for a user to extract a useful understanding of the concepts in the corpus becomes limited.

There remains a need for tools for the analysis of concepts extracted from a corpus of documents.

Any discussion of the prior art throughout the specification should in no way be considered as an admission that such prior art is widely known or forms part of the common general knowledge in the field.

### SUMMARY

The present disclosure is broadly directed to analysing concept nodes extracted from a corpus of documents. The analysis may include selecting a path between adjacent concept nodes using a calculated spatial cost function.

In a first form, although it need not be the only or indeed the broadest form, the disclosure resides in a method for determining a path through concept nodes, the method including the steps of:

calculating a spatial cost function between adjacent nodes in a lower dimensional layout representation of a network of concepts in a n-dimensional space and;

determining a path that follows a minimum spatial cost function through the concept nodes;

to thereby determine the path through concept nodes.

In another form the disclosure resides in a computer-implemented tool for determining a path through concept nodes within a network of nodes, the tool comprising:

a processor programmed to perform a series of processing steps, the processing steps including:

calculating a spatial cost function between adjacent nodes in a lower dimensional layout representation of a network of concepts in a n-dimensional space and;

determining a path that follows a minimum spatial cost function through the concept nodes;

a display device exhibiting the concept nodes and the determined path that follows the minimum spatial cost function.

In yet another form the disclosure resides in a computer program product said computer program product comprising:

a computer usable medium and computer readable program code embodied on said computer usable medium for determining a path through concept nodes, the computer readable code comprising:

a computer readable program code device (i) configured to cause the computer to effect the calculation of a spatial cost function between adjacent nodes in a lower dimensional layout representation of a network of concepts in a n-dimensional space; and

a computer readable program code device (ii) configured to cause the computer to determine a path that follows a minimum spatial cost function though the concept nodes.

In another form the disclosure resides in a computer system for determining a path through concept nodes, the system comprising:

a processor for calculating a spatial cost function between adjacent nodes in a lower dimensional layout representation of a network of concepts in a n-dimensional space and;

a processor for determining a path that follows a minimum spatial cost function through the concept nodes.

The calculated spatial cost function may be used to predict a next node in the path.

The path may be a descriptive path.

According to any of the above forms the calculated spatial cost function may be used to predict a next node in the path.

According to any of the above forms the path determined may comprise a descriptive path.

According to any of the above forms a next node in a path from the calculated spatial cost function may also be determined.

According to any of the above forms the path determined may be between two or more concept nodes.

According to any of the above forms the path determined may be between two concept nodes.

According to any of the above forms an origin concept node for the path may also be received.

The origin concept node may be an inputted origin concept node.

According to any of the above forms an inputted goal concept node may be received.

The goal concept node may be an inputted goal concept node.

According to any of the above forms the path determined may be between an origin concept node and a goal concept node.

According to any of the above forms the origin concept node may be a concept node with a highest frequency in the network of concepts.

According to any of the above forms the path determined may be between all concept nodes in the network of concepts.

According to any of the above forms the path determined may be between a subset of concept nodes in the network of concepts.

According to any of the above forms the path determined may comprise a hub node.

According to any of the above forms the path determined may comprise a peripheral concept node.

According to any of the above forms the path determined may be optimal in Euclidean metric.

According to any of the above forms the path determined may be more evenly distributed than a path determined by calculating a non-spatial cost function for a same network of concepts.

According to any of the above forms determining the path may comprise a calculation comprising Prim's algorithm.

According to any of the above forms determining the path may comprise searching the local space in relation to a current set of visited concept nodes.

According to any of the above forms determining the path may comprise a calculation comprising Kruskal's algorithm.

According to any of the above forms determining the path may comprise searching global space.

According to any of the above forms the spatial cost function may comprise:

$$f ( x ) = \frac{\sqrt{{( {x}_{1} - {x}_{2} )}^{2} + {( {y}_{1} - {y}_{2} )}^{2}}}{c}$$

wherein:
x₁, y₁ are co-ordinates for a source node;
x₂, y₂ are co-ordinates for a destination node; and
c is total co-occurrence frequency between source and destination nodes.

According to any of the above forms calculating the spatial cost function may comprise configuring a proportion of a distal component.

According to any of the above forms the spatial cost function may comprise:

$$f ( x ) = \frac{{( \sqrt{{( {x}_{1} - {x}_{2} )}^{2} + {( {y}_{1} - {y}_{2} )}^{2}} )}^{n}}{c}$$

wherein:
x₁, y₁ are co-ordinates for a source node;
x₂, y₂ are co-ordinates for a destination node;
c is total co-occurrence frequency between source and destination nodes; and
n is a real number.

According to any of the above forms the spatial cost function may comprise:

$$\frac{f ( x ) = {( \sqrt{{( {x}_{1} - {x}_{2} )}^{2} + {( {y}_{1} - {y}_{2} )}^{2} + {( {z}_{1} - {z}_{2} )}^{2}} )}^{n}}{c}$$

wherein:
x₁, y₁ are co-ordinates for a source node;
x₂, y₂ are co-ordinates for a destination node;
c is total co-occurrence frequency between source and destination nodes;
n is a real number;
z₁ is normalised occurrence frequency for the source node; and
z₂ is normalised occurrence frequency for the destination node.

According to any of the above forms calculating the spatial cost function may comprise bias to direct co-occurrence.

According to any of the above forms the spatial cost function may be globally monotonic.

According to any of the above forms the spatial cost function may not be globally monotonic.

According to any of the above forms the spatial cost function may take into account distal relationships between the concept nodes.

According to any of the above forms the spatial cost function calculated may comprise the inverse of a number of co-occurrences between concept nodes

According to any of the above forms calculating the spatial cost function may comprise a distal component multiplied as a power law.

According to any of the above forms the n-dimensional space may comprise two dimensions.

According to any of the above forms the n-dimensional space may comprise a planar layout of co-occurrence information.

According to any of the above forms n-dimensional space may comprise three dimensions.

According to any of the above forms the n-dimensional space may comprise occurrence frequency as the z-axis.

According to any of the above forms n-dimensional space may comprise a number of dimensions equal to the number of nodes.

According to any of the above forms the n-dimensional space may comprise a number of dimensions determined by the number of concept nodes.

According to any of the above forms each dimension in the n-dimensional space may be given equal significance.

According to any of the above forms the network of concepts may be selected from the group consisting of a network of genes; a network of proteins; a network of metabolites; a network of individuals and a network of social contacts.

One or more of the social contacts may carry an infection.

In this specification, the terms “comprises”, “comprising” or similar terms are intended to mean a non-exclusive inclusion, such that a method, system or apparatus that comprises a list of elements does not include those elements solely, but may well include other elements not listed.

It is an aspect of the present disclosure to provide a method for analysing concepts extracted from a corpus of documents.

It is also an aspect of the present disclosure to determine a path between concept nodes in a network of nodes.

Further aspects will be evident from the following description.

### BRIEF DESCRIPTION OF THE DRAWINGS

To assist in understanding the disclosure preferred embodiments will now be described with reference to the following figures in which:

FIG. 1 Graphical display of a network of nodes extracted from a corpus of documents according to Leximancer®.

FIG. 2 Flow chart showing one exemplary embodiment of the method of the disclosure.

FIG. 3 Flow chart showing a second exemplary embodiment of the method of the disclosure.

FIG. 4 Concept Spatial minimum spanning tree. All concepts are shown as nodes, and co-occurrence as edges. The concept “symbol” is the most significant hub, “concepts” and “language” are secondary hubs.

FIG. 5 Concept Space Literature minimum spanning tree. Major hubs are evident at the concept nodes “hippocampal,” “system,” and “symbol.”

FIG. 6 Comparison of betweenness centrality and occurrence frequency for each concept for a concept map, sorted by occurrence frequency. There is a positive correlation on the two measures, with the number of occurrences shown on the left hand axis as the line with diamond markers, while betweenness centrality is shown on the right hand axis as the line with box markers. Betweenness centrality rapidly drops to zero indicating there are no shortest paths that traverse these nodes.

FIG. 7 Comparison of degree centrality for the full network and minimum spanning tree, and occurrence frequency for a concept map. The occurrence frequency is shown on the left hand axis and is represented by the line with triangles. The line with boxes represents degree centrality for the full network, for the minimum spanning tree (MST) by the line with diamonds; both are shown on the right hand axis.

FIG. 8 Example path plotted on the minimum spanning tree for the Conceptual Spatial concept map. The origin is the node “reference” shown with the black outline and the white interior on the left hand side of the figure, the goal is the concept node “understanding” with the black outline and the white interior near the centre of the figure, and all traversed nodes are marked in black along the dark line.

FIG. 9 Example path plotted on the minimum spanning tree for the Conceptual Space Literature concept map where the path appears non-optimal when considering Euclidean locations of nodes.

FIG. 10 Cost function on creation of minimum spanning tree using Prim's algorithm on the concept space literature map. The order presented is the order in which each node is added to the tree based on the cost function for all currently traversed nodes and is non-monotonic in this example.

FIG. 11 Comparison of Prim's algorithm and Kruskal's algorithm for deriving a minimum spanning tree on a Conceptual Navigation concept map. (a) Cost function value for each node in order of creating the MST using Prim's algorithm; (b) Cost function value for each node in order of creating the MST using Kruskal's algorithm; (c) Resultant MST using Prim's algorithm; and (d) Resultant MST using Kruskal's algorithm.

FIG. 12 Comparison of paths from “set” to “place” in minimum spanning trees generated with different algorithms on the Conceptual Brain concept map. (a) The MST generated using Prim's algorithm directs a path through the distant central hub of “hippocampal;” while (b) the MST generated with Kruskal's algorithm takes a more direct, though possibly less informative path that does not traverse the central hub.

FIG. 13 Comparison of a minimum spanning tree with and without a spatially weighted cost function generated using Prim's algorithm. (a) MST with no spatial weighting to cost function; and (b) MST with a spatially weighted cost function.

FIG. 14 Comparison of minimum spanning tree with and without a spatially weighted cost function generated using Kruskal's algorithm. (a) MST with no spatial weighting to cost function; and (b) MST with a spatially weighted cost function.

FIG. 15 Minimum spanning tree using Prim's algorithm with non-spatially weighted cost function for a Concept Brain concept map with the most significant concept “hippocampal” removed.

FIG. 16 Minimum spanning tree using Prim's algorithm with spatially weighted cost function for the Concept Brain concept map with the most significant concept “hippocampal” removed.

FIG. 17 Minimum spanning tree using Prim's algorithm with modified distal cost function ratio with n=2.0. Local relationships are more likely to be followed than more distant nodes with a relatively low co-occurrence value.

FIG. 18 Comparison of Leximancer and Correspondence Analysis layouts. a) Leximancer MST using Prim's algorithm for Concept Brain example; and b). Correspondence analysis MST using Prim's algorithm. A distal cost function with a value of n=1.0 was used in both maps.

FIG. 19 MST path for user selected origin “rats” and goal “maze” on the Concept Brain concept map using a Leximancer layout. Prim's algorithm was utilised with a distal ratio value n=2.0.

FIG. 20 MST path for user selected origin “rats” and goal “maze” on the Concept Brain concept map using a CA layout. Prim's algorithm was utilised with a distal ratio value n=2.0.

FIG. 21 Shortest path with spatially weighted cost function for user selected origin “salads” and goal “parents” using a Leximancer layout and thematic circles.

FIG. 22 Example of a display showing links in a path and articles from the corpus of documents which contain the concepts associated with the links in the path.

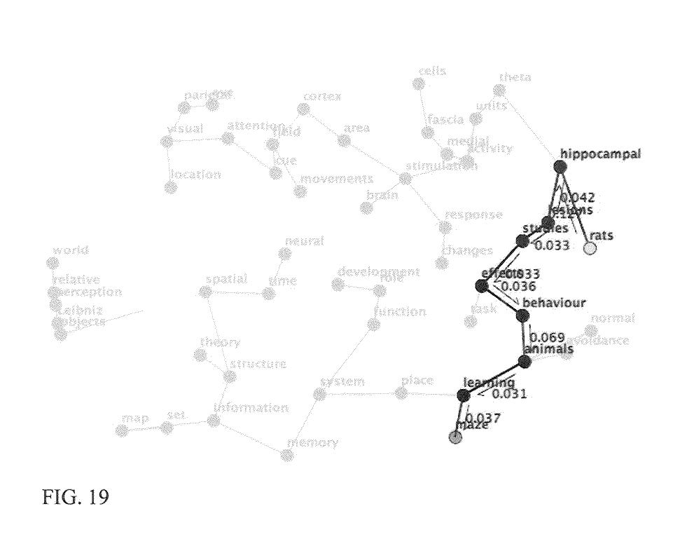

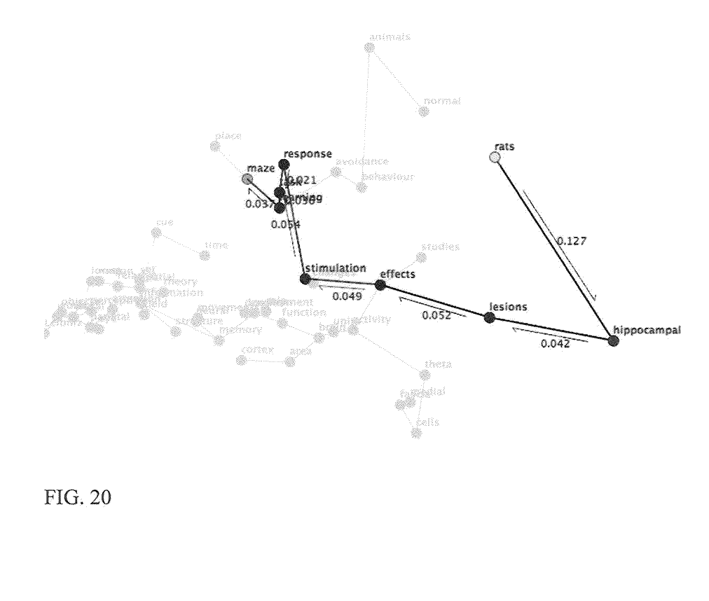

Table 1 The table shows the actual path taken in FIG. 19, with the conditional probability of each step, and the frequency occurrence for each traversed node.

Table 2 The table shows the actual path taken in FIG. 20, with the conditional probability of each step, and the frequency occurrence for each traversed node.

### DETAILED DESCRIPTION

In describing different embodiments of the present disclosure common reference numerals are used to describe like features.

In order to exemplify the disclosure the analysis of the dynamic corpus of documents will be explained using a network map produced by Leximancer®. It will be appreciated that the disclosure is not limited to application with Leximancer® but may be used with any system that produces a set and/or network of nodes. Examples of other systems that could be used with the present disclosure include, without limitation, systems that extract user-defined key words, common words and/or words over a particular letter-length.

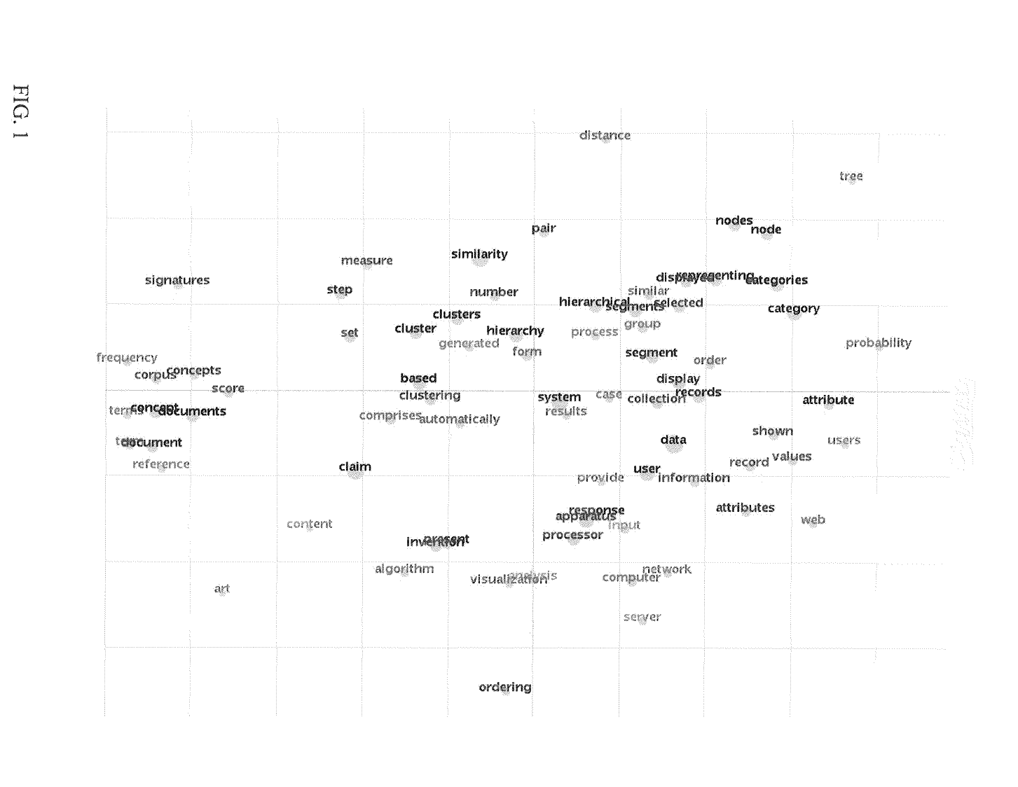

FIG. 1 displays a network map as produced by Leximancer® for a first corpus of documents which is a group of United States patents and patent applications. It will be appreciated that the disclosure is not limited to application with patent literature but may be used with any divisible corpus of documents. Each node appearing in the graph is a word representing a concept. Leximancer® automatically learns which words predict which concepts and automatically extracts the concepts from the corpus of documents.

The location of each node on the map is related to contextual similarity between concepts. The map is constructed by initially placing the concepts randomly on the grid. That is, concepts can be thought of as being connected to each other with springs of various lengths. The more frequently two concepts co-occur, the stronger will be the force of attraction (the shorter the spring), forcing frequently co-occurring concepts to be closer on the final map. However, because there are many forces of attraction acting on each concept, it is impossible to create a 2D or 3D map in which every concept is at the expected distance away from every other concept. Rather, concepts with similar attractions to all other concepts will become clustered together. That is, concepts that appear in similar contexts (i.e., co-occur with the other concepts to a similar degree) will appear in similar regions in the map. These regions may be grouped to identify themes.

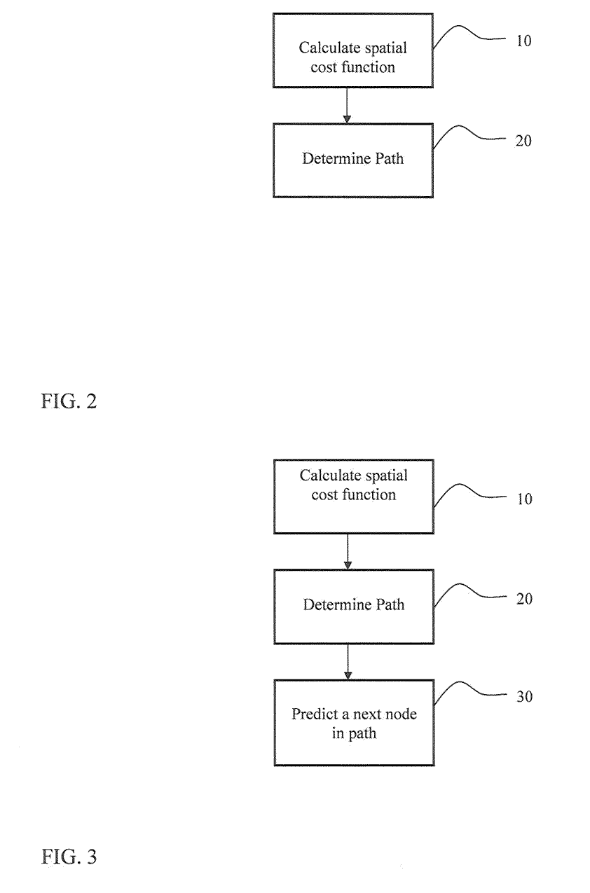

FIG. 2 is a flow chart that shows one exemplary embodiment of the disclosure. In 10 a spatial cost function is calculated for a network of nodes as produced by Leximancer®.

In 20 a path is calculated between the nodes. The path that is calculated may be a path that follows a minimum spatial cost function between adjacent nodes.

The path may be calculated for all number of nodes in the network or for a subset of nodes in the network.

The path may be calculated using a start or origin node and a goal node. The path may be a descriptive path which explains the relationship between the origin and goal concepts in the corpus of documents by way of the set of traversed nodes.

A “lower dimensional layout” is a layout in two, three or four dimensions. Preferably the layout is in two dimensions.

“n-dimensional space” is space with the number of dimensions determined by the integer n. For an arbitrary network of n+1 nodes, the network can always be laid out in a space of n dimensions. Typically n is larger than 3. n may be much larger than 3. n may be equal to or determined by the number of nodes. Suitably, n may be 3, 4, 5, 6, 7, 8, 9 or 10.

Such a layout is normally difficult to represent for visual inspection and comprehension, and can readily be projected into a lower dimensional space with little loss of information.

The method can be used to analyse concepts in a network of nodes from any suitable source. A person of skill in the art is readily able to select suitable sources for example, news, stock market information, scientific information and technical information.

One non-limiting example of scientific information is in the field of bioinformatics. In this non-limiting example a concept node denotes a gene in a network of genes, a protein in a network of proteins or a metabolite in a metabolic network.

Another non-limiting example is in a social network wherein, for example, a concept node denotes an individual in a social network.

Still another non-limiting example is in epidemiology wherein, for example, a concept node denotes an infected individual in a network of social contacts.

So that the disclosure may be readily understood and put into practical effect, reference is made to the following non-limiting Examples.

### EXAMPLES

### Method

A concept map was generated in Leximancer (Smith & Humphreys, 2006) from a set of electronic documents, with some refinement performed. The refinement was minor and consisted of combining similar words such as, “object” and “objects” into one concept. Other examples of words that were combined are “situation” and “situations” and “theory” and theories”.

The occurrence and co-occurrence was then utilised to generate a symmetric network diagram with each concept represented by a vertex and each two concepts that co-occur represented by an edge. The weight of the edge was determined by the count of co-occurrences for the two concepts.

A minimum spanning tree (MST) for the network diagram for each of nine concept maps was derived using Prim's algorithm (Prim, 1957) and plotted. The selected cost function was the inverse of the number of co-occurrences between both concepts, and the concept with the highest frequency chosen as the starting vertex. The co-ordinates for each concept generated in Leximancer were used on the diagram.

### Results

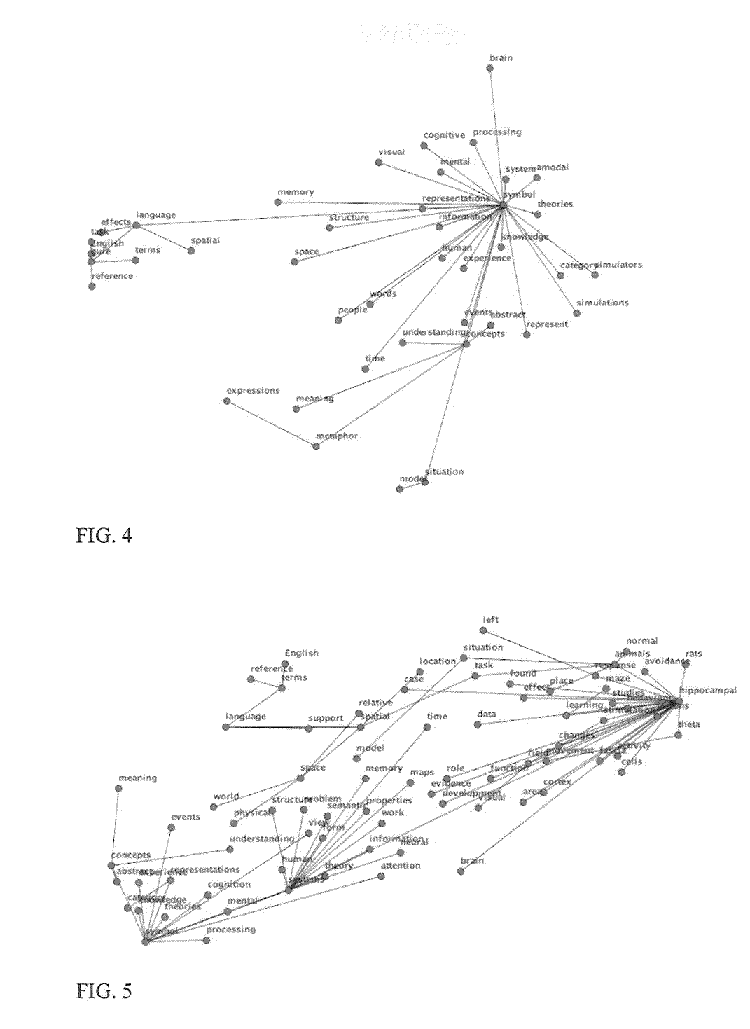

A stable, deterministic structure was derived with hubs of connections centred on the most significant concepts for each of the concept maps. FIG. 4 shows an example MST that was generated. Most of the MSTs showed a major hub at the most significant node, and for more dense maps, one or more additional hubs. FIG. 5 shows an example MST with multiple significant hubs.

### Discussion

The derived minimum spanning tree gave a non-ambiguous path to every node within the network such that there are no loops or alternate paths. It is possible for more than one MST to exist for a given network with the same net value, however all examples maintained stable MSTs when performed over multiple iterations. Even though some concepts co-locate on the map they did not become connected in the MST. For these concepts that may be semantically synonymous, to gain context it is necessary to traverse the local network through the MST. Although an MST gives a globally efficient network, it doesn't necessarily give a locally efficient network—not all shortest paths may be included in an MST.

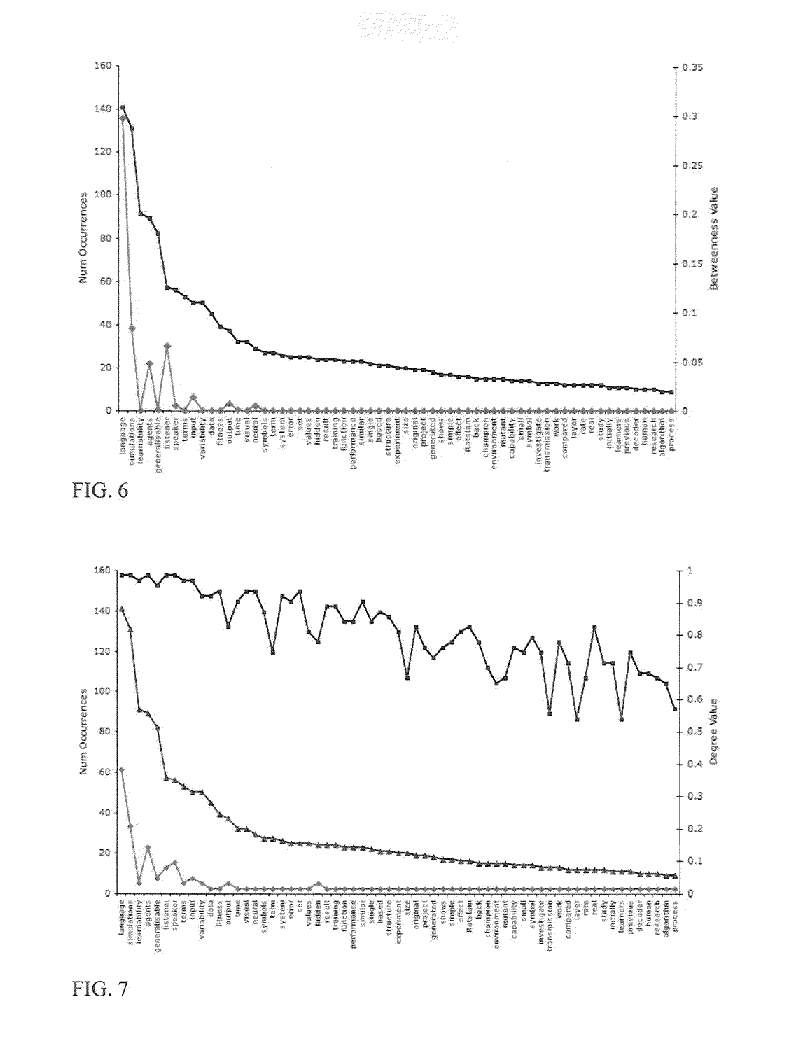

Each of the hubs on the MST ensures a path across the map to traverse through a significant concept because of the natural relationship between frequency and co-occurrence—the more frequently a concept occurs, the more likely it is to co-occur with other concepts. Additionally, the more frequent concepts are then relatively likely to co-occur with one another. With the goal of trying to improve cognition on a path through a conceptual space, the impact of visiting the core concepts gives a richer description of the underlying concepts. Betweenness centrality (Bavelas, 1948) was calculated for the full network as a measure of how important a node is within a network. An example of the positive correlation between frequency and betweenness centrality is shown in FIG. 6.

The inverse of the number of co-occurrences was selected for the cost function to ensure that the more connected two concepts, the better chance that the connection would be used. Although for the MST the scale of difference was not significant—as long as the value was lower, it gave a lower cost—it was of use when calculating shortest paths used for deriving betweenness centrality on a network.

Degree centrality was then calculated for both the full network and the MST. The full networks are generally to be very highly connected however many of the connections are weak. The MST successfully reduced the degree centrality measure to give a close correlation with occurrence frequency (see FIG. 7).

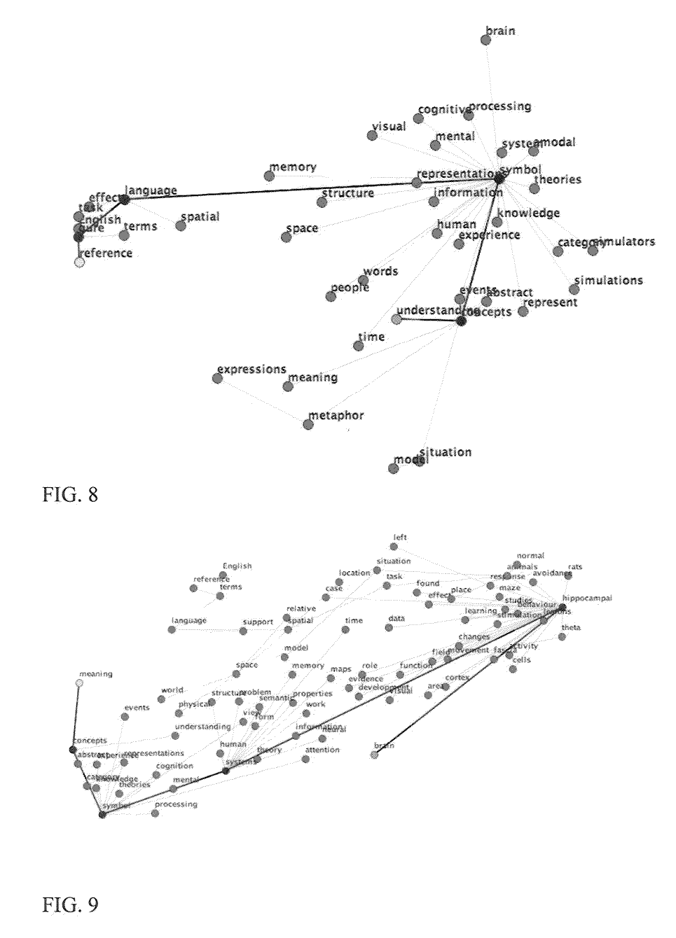

Origin and goal concepts were selected on the concept maps, and the paths on the minimum spanning trees plotted. FIG. 8 shows an example path, which shows the traversal passing through the major hubs on the MST. With many examples, the path is reasonably direct and does not appear unnecessarily long in the Euclidean space of the network.

FIG. 9, however, shows an example where the path is far more circuitous, despite traversing the primary nodes. In a two-dimensional layout, although “brain” is situated closely to “systems,” the path is forced to traverse the primary concept “hippocampal” which seems counterintuitive.

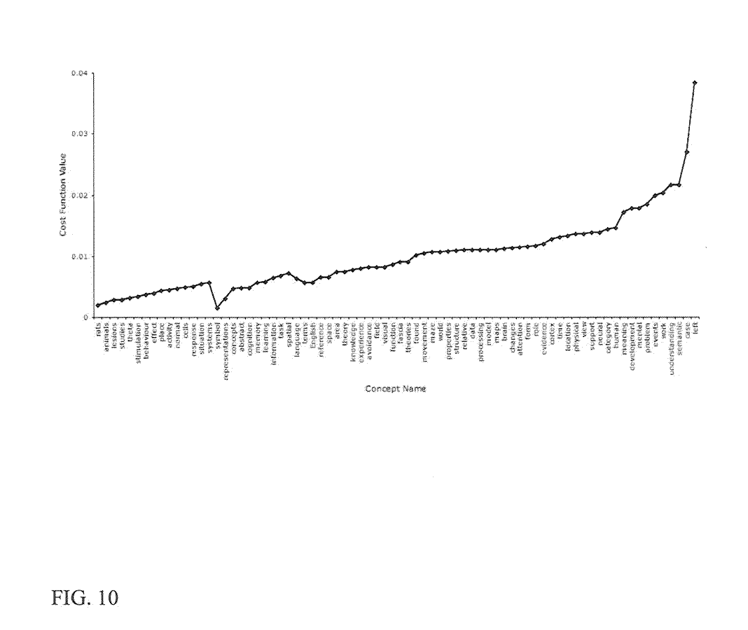

Part of this effect can be attributed to the flattening of the conceptual structure into a two-dimensional layout; when viewed in a higher dimensional plane, it is possible that the proximity of “brain” to “systems” is not as close. The cost function on the construction of the minimum spanning tree based on Prim's algorithm (Prim, 1957) was then plotted (see FIG. 10). The drops in the cost function value are not necessarily monotonically increasing, and show that local maxima have been reached when building the MST from the collection of related nodes. These local maxima could contribute to the paths that appear to be globally inefficient.

### Prim's Versus Kruskal's MST Algorithms

Two aspects of calculating the MST can be reviewed to address the issues with the MST: change the algorithm to use one that has a globally monotonic cost value such as Kruskal's algorithm (Kruskal, 1956); or to change the cost function to take distal relationships into consideration. Kruskal's algorithm was used with no change to the cost function to determine the effect of the local maxima. The initial expectation would not have a large overall impact due to the small number of local maxima occurrences.

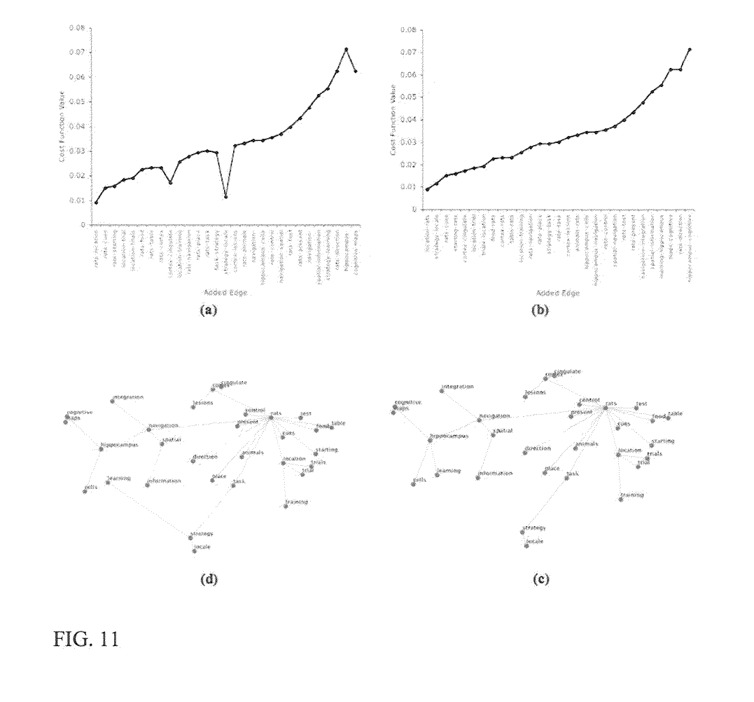

Although in many cases, the minimum spanning tree was very similar, there were examples where having a monotonically increasing cost function value gave a more efficient tree. FIG. 11 shows one such example concept map where Prim's algorithm has a non-monotonic cost function value with sharp drops and compares it to the cost function value using Kruskal's algorithm, and the change to the structure of the MST that is evident.

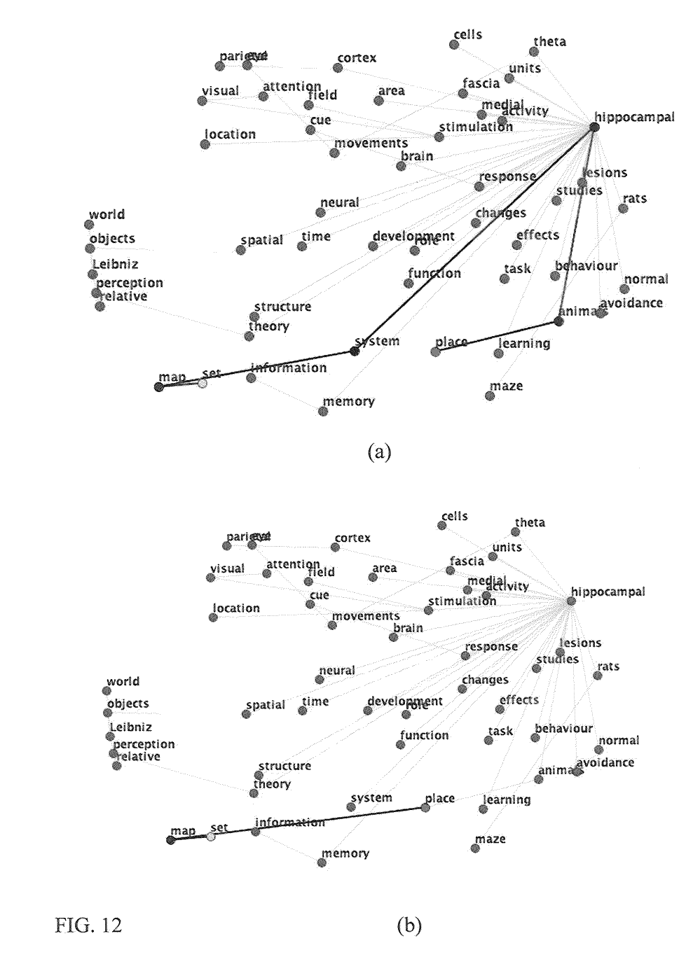

The order in which the MST is generated does not change the overall structure radically, however there are changes in some specific nodes around the leaves of the MST. FIG. 12 shows an example of a more direct path using Kruskal's MST with the same cost function. A shorter path can be derived for peripheral connections by choosing a closer hub where the connections are connected more strongly locally rather than forcing a path through the central hub. A shorter, more direct path may not necessarily be the most effective if cognition of concepts is desired.

### Spatial Cost Function

The cost function was then modified to include a spatial component. The distances between nodes as laid out by Leximancer (Smith & Humphreys, 2006) was calculated and incorporated as part of the cost function:

$$f ( x ) = \frac{\sqrt{{( {x}_{1} - {x}_{2} )}^{2} + {( {y}_{1} - {y}_{2} )}^{2}}}{c}$$

where:
x₁, y₁ are the co-ordinates for the source node;
x₂, y₂ are the co-ordinates for the destination node; and
c is the total co-occurrence frequency between the source and destination nodes.

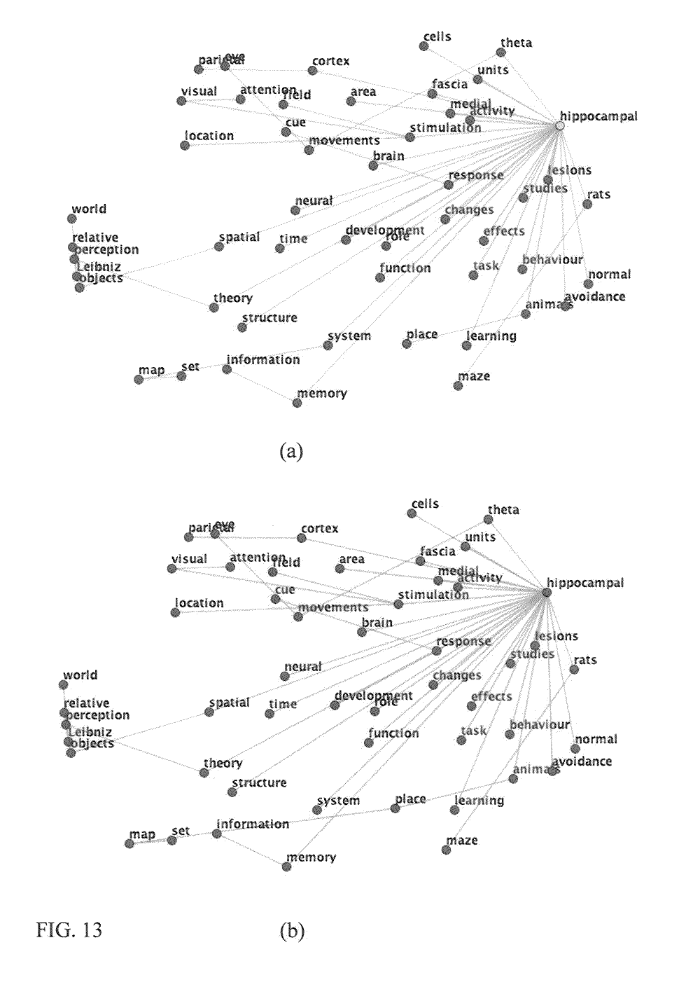

MSTs where then generated using both Prim's and Kruskal's algorithms and compared to each other and to the nondistal cost function. FIG. 13 shows a comparison where a spatially weighted cost function is used.

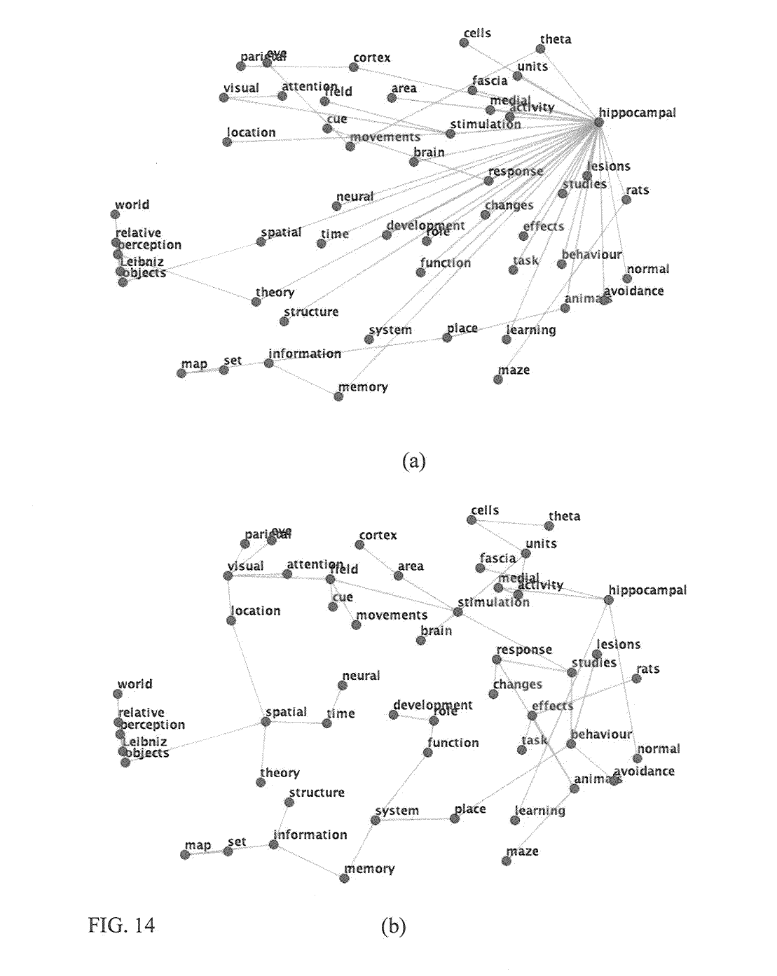

The structure of the MST is much more evenly distributed for the spatially weighted cost function than for the cost function based only on the inverse of co-occurrence count. There is an absence of the large centrally significant hub; instead, there is more structure developed from the smaller hubs and concepts. The same example for Kruskal's algorithm is shown in FIG. 14, and has a similar structure as Prim's algorithm.

There are some differences between Prim's and Kruskal's spatially weighted minimum spanning trees (see FIGS. 13(b) and 14(b) for a common example). Although they both exhibit the same general behaviour, Prim's tend to be more locally connected, with fewer edges crossing nearby edges than Kruskal's. This structural difference can be attributed again to the monotonically increasing value of the cost function value; Kruskal's algorithm searches the global space for the next least cost edge, whereas Prim's searches the local space in relation to the current set of visited nodes for the next least cost edge. With the cost function including a spatial weighting, this difference results in a more locally distributed spanning tree.

### Context

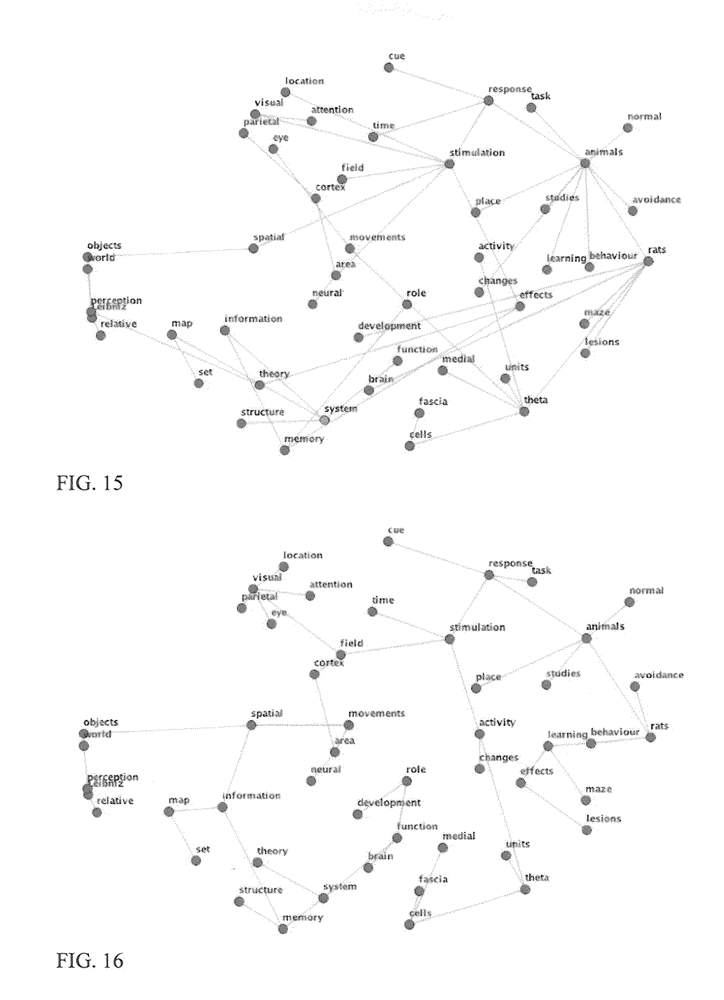

For a network with a heavily skewed attraction to a single node such as shown in FIGS. 13(a) and 14(a), the nexus point can be considered as a “context” for the rest of the map, that is, all concepts in the map are used within the context of this nexus point. The MST was then modified by manually deleting the nexus point from the concept list and regenerating the concept map in Leximancer (Smith & Humphreys, 2006). FIG. 15 shows the same example from FIG. 13 using a spatially unweighted cost function with the nexus point of “hippocampal” removed and generated with Prim's algorithm. The MST generated using. Kruskal's algorithm shows a similar structure as for Prim's and is not shown.

The underlying concept map has changed in layout due to the refactoring of the map and the difference in repulsions with the removal of “hippocampal.” The base structure of the MST has the more evenly distributed appearance of the MST that includes “hippocampal” with the spatially weighted cost function.

Changing the cost function to include spatial weightings tends to remove nearly all of the hubs (see FIG. 16). Although having a single, dominant hub is not desirable, removing the primary hubs makes the MST less useful as traversals tend to be too specific and loses global scope when considering cognition. A secondary issue of removing a central node if it is dominant is the arbitrary nature of choosing a threshold for when a node can be considered to be dominant.

The final parameter to consider when using Prim's algorithm, is the selection of the starting or origin node, from where the rest of the tree is expanded. For all MSTs so far, the most significant concept by total frequency was selected as the starting node. The simulation was modified so that any node on the concept map could be selected as the starting node, at which point the MST would be generated. The expectation was that the MST would be quite different around the starting node, then settling into a similar structure to that generated using the most significant node as the starting point. This expectation, however, proved to be incorrect; the MST generated was identical regardless of where Prim's algorithm started if the cost function was unique. In fact, the MST appears to be deterministic in all cases where the cost function is unique. For those cases where the cost function was not unique, only minor changes were reflected in the MST. An interesting feature of the spatially weighted cost function is that due to the precision of the calculated distances, the cost function becomes unique, even if the co-occurrence values are not.

Examining all of the permutations of minimum spanning tree algorithms, cost functions and pre-processing, the most useful configuration for creating a central path through the concept map that traverses the globally significant nodes yet takes local relationships into consideration is Prim's algorithm with a spatially weighted cost function. The MST provides a framework for providing efficient pathways for navigating a concept map when cognition is desired, and will be used as part of the derivation of a “conceptual landscape.”

### Adjusted Spatial Cost Function

Next, the application was enhanced so that the proportion of the distal component of the cost function was made configurable. The new cost function can be expressed as:

$$f ( x ) = \frac{{( \sqrt{{( {x}_{1} - {x}_{2} )}^{2} + {( {y}_{1} - {y}_{2} )}^{2}} )}^{n}}{c}$$

where x₁, x₂, x₂, y₂ and c are as defined above; and
n is a real number.

By setting n to zero, the distal component of the cost function can be completely ignored; setting it to one keeps the existing behaviour. A value of n=2.0 was chosen for experimentation—a higher value may under-represent the co-occurrence frequency component of the cost value and tended to converge rapidly toward a stable map based completely on distance.

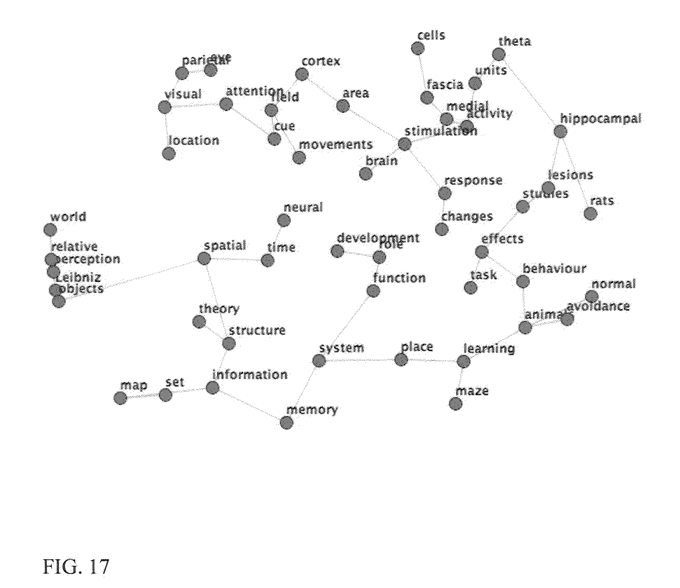

Comparing the minimum spanning tree with a direct relationship between distance and co-occurrence (see FIG. 13b) with a minimum spanning tree that invoked power law relationship (see FIG. 17) shows that local nodes are more likely to be connected than more distant nodes with similar co-occurrence values. This behaviour tends to explore the local space around a node and can give a more specific context for the relationships between local nodes.

### Correspondence Analysis as an Alternative Layout

The Leximancer map layout uses a proprietary algorithm, so an alternative in the public domain was also used to test the minimum spanning tree logic. Correspondence analysis (Greenacre, 1984) was chosen due to its ability to reduce dimensionality to an appropriate two-dimensional layout.

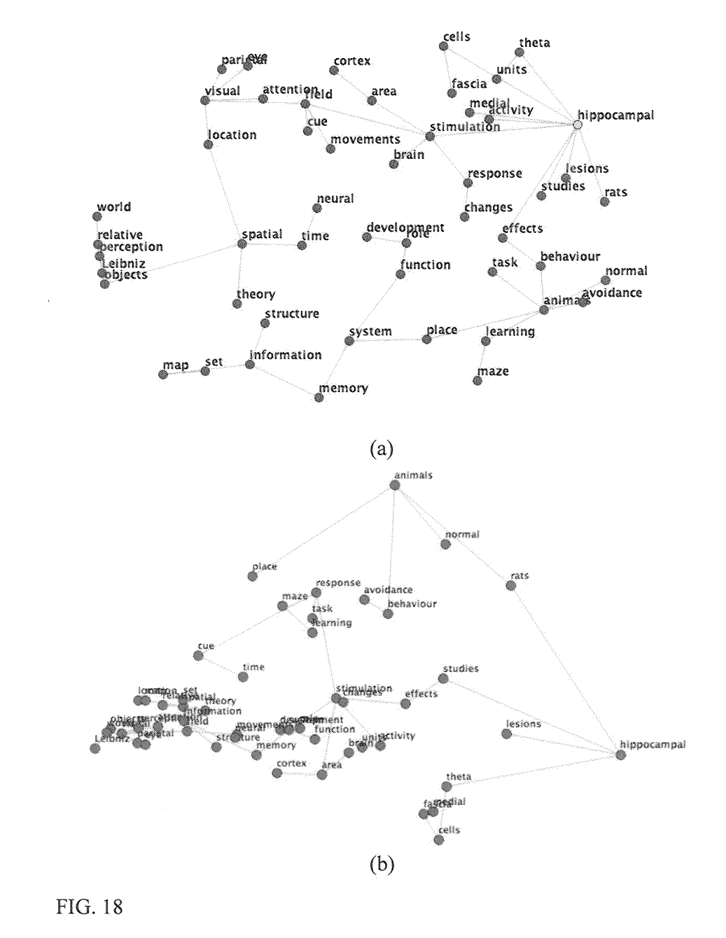

Although the map layout for correspondence analysis (CA) was quite different to that of Leximancer, the two dimensional layout preserved the co-occurrence relationships evident in the Leximancer layout (see FIG. 18). In this example, the node “hippocampal” was a very highly connected node, and although it was skewed away from the centre of the map, the primary relationships between related nodes as seen in FIG. 18(a) are preserved in FIG. 18(b). The locations for “hippocampal”, “lesions”, “rats” and “theta” have been translated as they have followed “hippocampal” to be peripheral on the CA map, yet in general their individual relationships are recognisable in both maps even though node clusters have been shifted. Other maps show a similar relationship between the Leximancer and CA layouts.

Choosing a Path through a Map

Finally the user was given the ability to choose an origin and goal concept on either map layout, and then the path between them following the MST was derived and presented (see FIG. 19). The set of traversed nodes qualitatively gave a descriptive path from the origin of “rats” to the goal of “maze.” The conditional probability for each step is in the table on the right hand side and on the graph next to an arrow indicating the direction of the path taken, and will be discussed in more detail below.

The same origin and goal were then also selected using a CA layout with all other parameters held constant (see FIG. 20). Although the paths were not exactly the same, they were very similar with the Leximancer layout containing the additional step of “studies” between “lesions” and “effects”, and the sequence “behaviour” and “animals” replaced by the sequence “stimulation,” “response” and “task” in the CA layout.

It is evident that the use of an MST with a distal component multiplied as a power law can give a qualitative “story” from a selected origin and goal on a concept map, using either the proprietary Leximancer layout or the public domain CA layout.

Incorporating Altitude into the Cost Function

The initial motivation for the extra term, compared with the spanning tree cost function discussed above, was to follow pathways where the forward and backward conditional probability were similar at each step. This can be thought of in a couple of ways. One way is to see a high conditional probability as a logical implication. If the backward conditional probability is also high this approximates ‘implies both ways’ or equivalence. The other way this can be thought of is that we wish to prevent sudden changes in the generality of the path. Going rapidly from the specific to the general loses precision in meaning, which is equivalent to losing precision in location in spatial navigation. This essentially throws away information. Going rapidly from the general to the specific is a weakly justified increase in precision.

To follow pathways where forward and backward conditional probability are more similar at each step, we conceptualized the concept terrain in 3D, with occurrence frequency as the altitude (z axis) and the co-occurrence information generating the x-y planar layout (as described earlier). We then see that nodes in this space which are close in x-y terms and at similar altitude (z) have strong co-occurrence and similar occurrence frequencies. Thus, their forward and backward relative frequencies will be high and of similar size. To operationalize this, we want to find pathways between two points whose displacement vector between them in x-y-z space is shorter.

Noting that proximity in the x-y plane results from a combination of both direct co-occurrence and/or indirect co-occurrence (via common third-party nodes), we can add the constraint that we would prefer to follow nodes with stronger direct co-occurrence support, to try to increase direct textual support for each step in the path.

Combining these constraints, we formulate the cost function for the shortest path algorithm to be:

$$f ( x ) = \frac{{( \sqrt{{( {x}_{1} - {x}_{2} )}^{2} + {( {y}_{1} - {y}_{2} )}^{2} + {( {z}_{1} - {z}_{2} )}^{2}} )}^{n}}{c}$$

where x₁, x₂, x₂, y₂, c and n are as defined above;
z₁ is the normalised occurrence frequency for the source node; and
z₂ is the normalised occurrence frequency for the destination node.

The altitude term may be normalised to a value between 0 and 1 to match the scaling of the x-y plane, thus giving equal significance to each of the three axes.

### Shortest Paths for Probability of a Selected Path

In FIGS. 19 and 20, the conditional probability for each step is shown on both the graph and in Tables 1 and 2, respectively. Starting from a probability of one (i.e., the user has selected this node and therefore will always occur), the conditional probability of each step in the sequence from node x to node x+1 is calculated as a proportion of all connections to node x+1. Although this value gives a global probability of each step, the values are underestimates of the true probability of travelling from node x to node x+1, because only the single direct connection path between them is considered, rather than all paths that can be taken. Thus when calculating the total probability of the entire path by multiplying all steps together, then a low, underestimated value results.

To calculate the actual probability incorporating all possible paths is a problem of combinatorial explosion, and so a rationalised representation for the probability was chosen instead. When the cost function includes the distal component taken to a power, there is convergence between the path taken from an origin to a goal when using the MST path or using the shortest path. Given this convergence, each step is then represented as the proportion of the shortest path from the origin to the goal, which is a closer approximation of the probability for each step. Further work in this area is ongoing.

Combination with Thematic Groupings

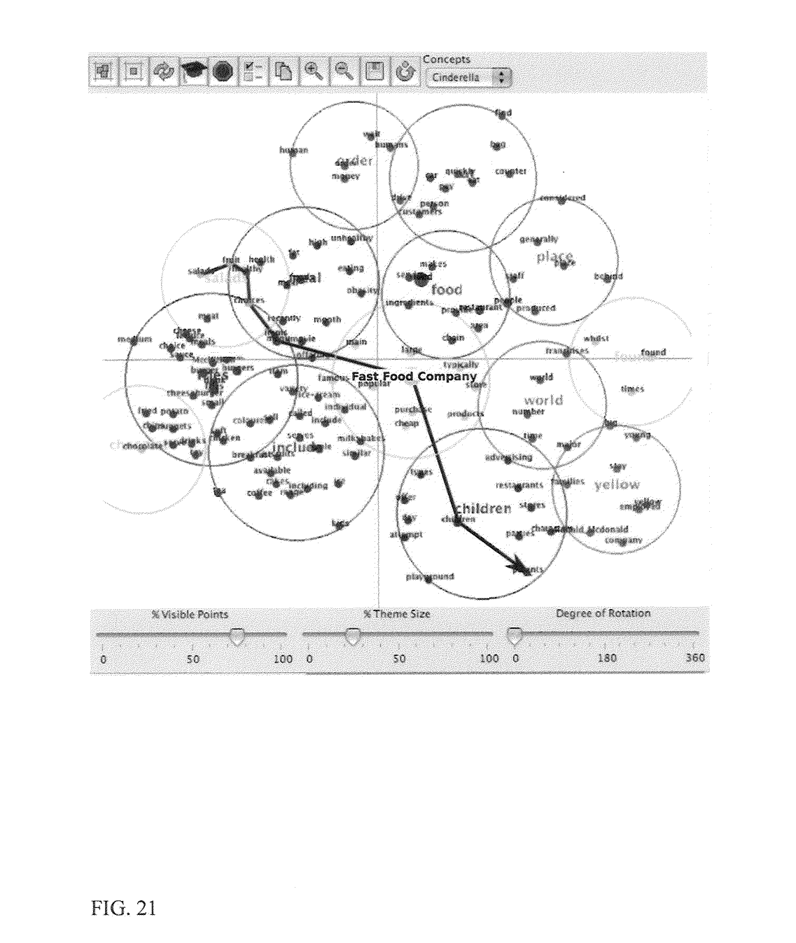

FIG. 21 shows a network map as produced by Leximancer® in which nodes are grouped into themes as described in PCT/AU2006/000546, published as WO2006/113970. The spatial region within which all nodes are considered to be related to the same theme is automatically determined. The boundary parameter distance is a user determined distance on the graph which influences the relative extent of the spatial regions.

The set of traversed nodes qualitatively gave a descriptive path from the origin of “salads” to the goal of “parents”. From “salads” to “parents” the nodes “fruit”, “healthy”, “choices”, “menu”, “Company X” (shown as “Fast Food Company” in FIG. 21) and “child” were traversed.

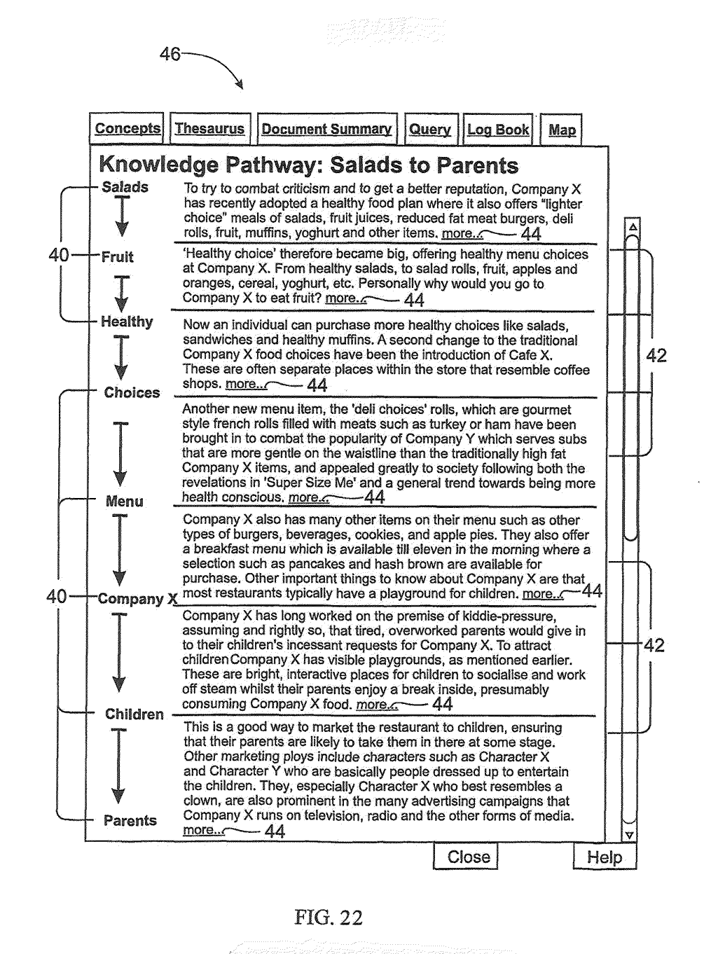

FIG. 22 shows a display 46 that may be shown together with the descriptive path. In FIG. 22 links 40 in the path are aligned with text from articles 42 from the corpus of documents that contain the relevant concepts in the path.

By clicking on a link 44 the entire article 42 containing the relevant concept may be viewed.

Throughout this specification, the aim has been to describe the preferred embodiments of the disclosure without limiting the disclosure to any one embodiment or specific collection of features. Various changes and modifications may be made to the embodiments described and illustrated herein without departing from the broad spirit and scope of the invention.

All computer programs, algorithms, patent and scientific literature referred to in this specification are incorporated herein by reference in their entirety.

### Tables

TABLE 1
Path Detail

| Concept | Probability | Frequency |
|---|---|---|
| Rats | 1.0 | 875 |
| Hippocampal | 0.127 | 1819 |
| Lesions | 0.042 | 432 |
| Studies | 0.033 | 645 |
| Effects | 0.033 | 509 |
| Behaviour | 0.036 | 551 |
| Animals | 0.069 | 781 |
| Learning | 0.031 | 442 |
| Maze | 0.037 | 206 |

TABLE 2
Path Detail

| Concept | Probability | Frequency |
|---|---|---|
| Rats | 1.0 | 875 |
| Hippocampal | 0.127 | 1819 |
| Lesions | 0.042 | 432 |
| Effects | 0.052 | 509 |
| Stimulation | 0.049 | 754 |
| Response | 0.054 | 611 |
| Task | 0.021 | 259 |
| Learning | 0.036 | 442 |
| Maze | 0.037 | 206 |

1.-36. (canceled)

37. A method for determining a path through concept nodes, the method including the steps of:
calculating a spatial cost function between adjacent concept nodes in a lower dimensional layout representation of a network of concepts in an n-dimensional space and;
determining a path that follows a minimum spatial cost function through the concept nodes;
to thereby determine the path through concept nodes.

38. The method of claim 37 wherein the calculated spatial cost function is used to predict a next node in the path.

39. The method of claim 37 further including the step of receiving an origin concept node for the path.

40. The method of claim 37 further including the step of receiving a goal concept node.

41. The method of claim 37 wherein the spatial cost function comprises a spatial cost function selected from:
$$f ( x ) = \frac{\sqrt{{( {x}_{1} - {x}_{2} )}^{2} + {( {y}_{1} - {y}_{2} )}^{2}}}{c}$$
wherein:
x₁, y₁ are co-ordinates for a source node;
x₂, y_{z} are co-ordinates for a destination node; and
c is total co-occurrence frequency between source and destination nodes;
$$f ( x ) = \frac{{( \sqrt{{( {x}_{1} - {x}_{2} )}^{2} + {( {y}_{1} - {y}_{2} )}^{2}} )}^{n}}{c}$$
wherein:
x₁, y₁ are co-ordinates for a source node;
x₂, y_{z} are co-ordinates for a destination node;
c is total co-occurrence frequency between source and destination nodes; and
n is a real number; and
$$f ( x ) = \frac{{( \sqrt{{( {x}_{1} - {x}_{2} )}^{2} + {( {y}_{1} - {y}_{2} )}^{2} + {( {z}_{1} - {z}_{2} )}^{2}} )}^{n}}{c}$$
wherein:
x₁, y₁ are co-ordinates for a source node;
x₂, y₂ are co-ordinates for a destination node;
c is total co-occurrence frequency between source and destination nodes;
n is a real number;
z₁ is normalised occurrence frequency for a source node; and
z₂ is normalised occurrence frequency for a destination node.

42. A computer-implemented tool for determining a path through concept nodes within a network of nodes, the tool comprising:
a processor programmed to perform a series of processing steps, the processing steps including:
calculating a spatial cost function between adjacent nodes in a lower dimensional layout representation of a network of concepts in a n-dimensional space and;
determining a path that follows a minimum spatial cost function through the concept nodes;
a display device exhibiting the concept nodes and the determined path that follows the minimum spatial cost function.

43. The computer-implemented tool of claim 42 wherein the calculated spatial cost function is used to predict a next node in the path.

44. The computer-implemented tool of claim 42 wherein the processing steps further include the step of receiving an inputted origin concept node for the path.

45. The computer-implemented tool of claim 42 wherein the processing steps further include the step of receiving an inputted goal concept node for the path.

46. The computer-implemented tool of claim 42 wherein the spatial cost function comprises a spatial cost function selected from:
$$f ( x ) = \frac{\sqrt{{( {x}_{1} - {x}_{2} )}^{2} + {( {y}_{1} - {y}_{2} )}^{2}}}{c}$$
wherein:
x₁, y₁ are co-ordinates for a source node;
x₂, y₂ are co-ordinates for a destination node; and
c is total co-occurrence frequency between source and destination nodes;
$$f ( x ) = \frac{{( \sqrt{{( {x}_{1} - {x}_{2} )}^{2} + {( {y}_{1} - {y}_{2} )}^{2}} )}^{n}}{c}$$
wherein:
x₁, y₁ are the co-ordinates for a source node;
x₂, y₂ are the co-ordinates for a destination node;
c is the total co-occurrence frequency between source and destination nodes; and
n is a real number; and
$$f ( x ) = \frac{{( \sqrt{{( {x}_{1} - {x}_{2} )}^{2} + {( {y}_{1} - {y}_{2} )}^{2} + {( {z}_{1} - {z}_{2} )}^{2}} )}^{n}}{c}$$
wherein:
x₁, y₁ are co-ordinates for a source node;
x₂, y₂ are co-ordinates for a destination node;
c is total co-occurrence frequency between source and destination nodes;
n is a real number;
z₁ is normalised occurrence frequency for a source node; and
z₂ is normalised occurrence frequency for a destination node.

47. A computer program product, said computer program product comprising:
a computer usable medium and computer readable program code embodied on said computer usable medium for determining a path through concept nodes, the computer readable code comprising:
a computer readable program code device (i) configured to cause the computer to effect the calculation of a spatial cost function between adjacent nodes in a lower dimensional layout representation of a network of concepts in a n-dimensional space; and
a computer readable program code device (ii) configured to cause the computer to determine a path that follows a minimum spatial cost function though the concept nodes.

48. The computer program product of claim 47 wherein the calculated spatial cost function is used to predict a next node in the path.

49. The computer program product of claim 47 wherein the computer readable code further comprises a computer readable program code device configured to cause the computer to receive an inputted origin concept node for the path.

50. The computer program product of claim 47 wherein the computer readable code further comprises a computer readable program code device configured to cause the computer to receive an inputted goal concept node.

51. The computer program product of claim 47 wherein the spatial cost function comprises a spatial cost function selected from:
$$f ( x ) = \frac{\sqrt{{( {x}_{1} - {x}_{2} )}^{2} + {( {y}_{1} - {y}_{2} )}^{2}}}{c}$$
wherein:
x₁, y₁ are co-ordinates for a source node;
x₂, y₂ are co-ordinates for a destination node; and
c is total co-occurrence frequency between the source and destination nodes;
$$f ( x ) = \frac{{( \sqrt{{( {x}_{1} - {x}_{2} )}^{2} + {( {y}_{1} - {y}_{2} )}^{2}} )}^{n}}{c}$$
wherein:
x₁, y₁ are co-ordinates for a source node;
x₂, y₂ are co-ordinates for a destination node;
c is total co-occurrence frequency between source and destination nodes; and
n is a real number; and
$$f ( x ) = \frac{{( \sqrt{{( {x}_{1} - {x}_{2} )}^{2} + {( {y}_{1} - {y}_{2} )}^{2} + ( {z}_{1} - {z}_{2} )} )}^{n}}{c}$$
wherein:
x₁, y₁ are co-ordinates for a source node;
x₂, y₂ are co-ordinates for a destination node;
c is total co-occurrence frequency between source and destination nodes;
n is a real number;
z₁ is normalised occurrence frequency for a source node; and
z₂ is normalised occurrence frequency for a destination node.

52. A computer system for determining a path through concept nodes, the system comprising:
a processor for calculating a spatial cost function between adjacent nodes in a lower dimensional layout representation of a network of concepts in a n-dimensional space and;
a processor for determining a path that follows a minimum spatial cost function through the concept nodes.

53. The computer system of claim 52 wherein the calculated spatial cost function is used to predict a next node in the path.

54. The computer system of claim 52 further comprising a processor for receiving an origin concept node for the path.

55. The computer system of claim 52 further comprising a processor for receiving an goal concept node.

56. The computer system of claim 52 wherein the spatial cost function comprises a spatial cost function selected from:
$$f ( x ) = \frac{\sqrt{{( {x}_{1} - {x}_{2} )}^{2} + {( {y}_{1} - {y}_{2} )}^{2}}}{c}$$
wherein:
x₁, y₁ are co-ordinates for a source node;
x₂, y₂ are co-ordinates for a destination node; and
c is total co-occurrence frequency between source and destination nodes;
$$f ( x ) = \frac{{( \sqrt{{( {x}_{1} - {x}_{2} )}^{2} + {( {y}_{1} - {y}_{2} )}^{2}} )}^{n}}{c}$$
wherein:
x₁, y₁ are co-ordinates for a source node;
x₂, y₂ are co-ordinates for a destination node;
c is total co-occurrence frequency between source and destination nodes; and
n is a real number; and
$$f ( x ) = \frac{{( \sqrt{{( {x}_{1} - {x}_{2} )}^{2} + {( {y}_{1} - {y}_{2} )}^{2} + {( {z}_{1} - {z}_{2} )}^{2}} )}^{n}}{c}$$
wherein:
x₁, y₁ are co-ordinates for a source node;
x₂, y₂ are co-ordinates for a destination node;
c is total co-occurrence frequency between source and destination nodes;
n is a real number;
z₁ is normalised occurrence frequency for a source node; and
z₂ is normalised occurrence frequency for a destination node.
